(19) United States
(12) Patent Application Publication
(10) Pub. No.: US 2021/0081901 A1
(43) Pub. Date: Mar. 18, 2021

(54) INFORMATION PROCESSING SYSTEM AND NON-TRANSITORY COMPUTER READABLE MEDIUM

(71) Applicant: FUJI XEROX CO., LTD., Tokyo (JP)

(72) Inventors: Izumi NAKANO, Kanagawa (JP); Nana AKIMOTO, Kanagawa (JP); Teppei AOKI, Kanagawa (JP)

(73) Assignee: FUJI XEROX CO., LTD., Tokyo (JP)

(21) Appl. No.: 16/776,515

(22) Filed: Jan. 30, 2020

(30) Foreign Application Priority Data
Sep. 18, 2019 (JP) 2019-169395

(51) Int. Cl. G06Q 10/10; G06Q 10/02; G06Q 10/06

(52) U.S. Cl. CPC G06Q 10/1091; G06Q 10/0631; G06Q 10/02

(57) ABSTRACT

An information processing system includes a specifying unit and a display unit. The specifying unit specifies an employee's use of a designated work place predetermined as a place for business among work places available to unspecified persons. When the employee's use of the designated work place is specified, the display unit displays, in a screen, the use of the designated work place as the employee's business use.

### CROSS-REFERENCE TO RELATED APPLICATIONS

This application is based on and claims priority under 35 USC 119 from Japanese Patent Application No. 2019-169395 filed Sep. 18, 2019.

### BACKGROUND

### (i) Technical Field

The present disclosure relates to an information processing system and a non-transitory computer readable medium.

### (ii) Related Art

For example, Japanese Unexamined Patent Application Publication No. 2001-312583 discloses a method of managing visiting destinations. The method is characterized by, in a process, for example, of managing visiting destinations, causing a person who goes out to carry a terminal which is capable of submitting transmission for locating the person, such as a simple portable phone, and by having a storage device for storing the locations of customers and the visiting history of the person. The data is reflected to the attendance records, the sales daily reports, and the like of the person. Thus, the daily management work of a person who goes out may be reduced, and accurate visiting management may be provided.

More and more cases have occurred in which, not only does an employee work, for example, inside their company, but also, in various periods, an employee works in various environments. Under this situation, when an employee works, for example, outside their company, it is difficult to determine whether or not the work is for business. This increases the work load on a manager who manages employees' attendance.

### SUMMARY

Aspects of non-limiting embodiments of the present disclosure relate to a technique which reduces the work load on a manager who does attendance management including the case in which employees work outside.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a specifying unit and a display unit. The specifying unit specifies an employee's use of a designated work place predetermined as a place for business among work places available to unspecified persons. When the employee's use of the designated work place is specified, the display unit displays, in a screen, the use of the designated work place as the employee's business use.

### BRIEF DESCRIPTION OF THE DRAWINGS

Exemplary embodiment of the present disclosure will be described in detail based on the following figures, wherein:

FIG. 1 is a diagram illustrating the entire configuration of an information processing system according to the present exemplary embodiment;

FIG. 2 is a block diagram illustrating the functional configuration of a work place management server according to the present exemplary embodiment;

FIG. 3 is a block diagram illustrating the functional configuration of an attendance management server according to the present exemplary embodiment;

FIG. 4 is a diagram illustrating exemplary activity information displayed by an activity information display unit according to the present exemplary embodiment;

FIG. 5 is a flowchart of determination as to a business duration which is performed by an activity information display unit according to the present exemplary embodiment;

FIG. 6 is a diagram illustrating an exemplary report reception image displayed by a report receiving unit according to the present exemplary embodiment;

FIG. 7 is a diagram illustrating an exemplary approval reception image displayed by an approval receiving unit according to the present exemplary embodiment; and

FIG. 8 is a diagram illustrating an exemplary hardware configuration of an employee terminal according to the present exemplary embodiment.

### DETAILED DESCRIPTION

The present exemplary embodiment will be described in detail below by referring to the attached drawings.

### An Information Processing System 1

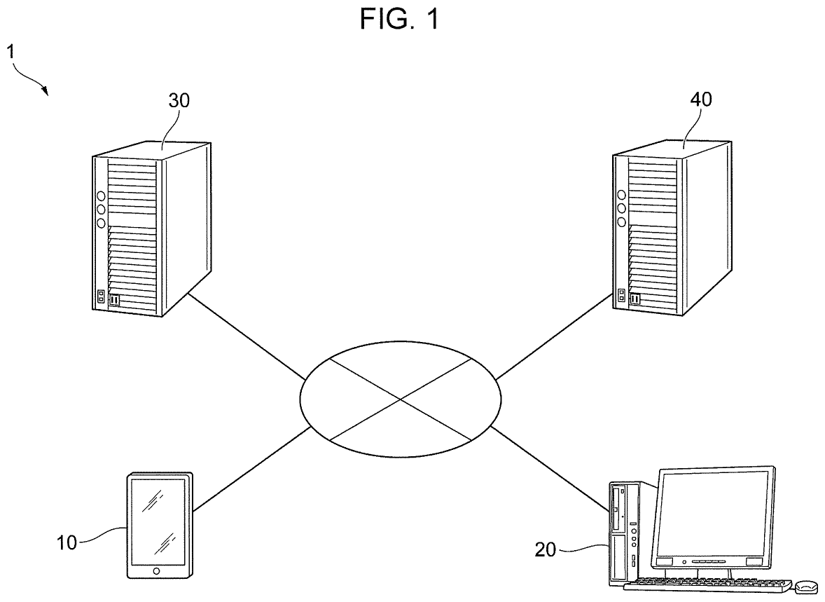

FIG. 1 is a diagram illustrating the entire configuration of an information processing system 1 according to the present exemplary embodiment.

As illustrated in FIG. 1, the information processing system 1 according to the present exemplary embodiment includes an employee terminal 10 used by an employee, a manager terminal 20 used by a manager who manages employees' attendance, a work place management server 30 which manages the employees' use of designated work places, and an attendance management server 40 which manages the employees' attendance.

In the information processing system 1 according to the present exemplary embodiment, the employee terminal 10, the manager terminal 20, the work place management server 30, and the attendance management server 40 are connected to one another over a network.

The network according to the present exemplary embodiment is a communication network used in data communication between apparatuses included in the information processing system 1. The network type is not limiting as long as the network is capable of receiving/transmitting data. For example, the Internet, a local area network (LAN), and a wide area network (WAN) may be used. A communication line used in data communication may be wired or wireless. The apparatuses may be connected to each other through multiple networks or communication lines.

For example, attendance management in an organization such as a company involves reception of an employee's report about a clock-in time and a clock-out time (hereinafter referred to as clock-in and clock-out times). Durations, which are approved by a manager as the employee's working hours, between the clock-in and clock-out times reported by the employee are handled, for example, as actual working hours. For example, in addition to work in a building of the company, the employee may work outside a building of the company. When an employee thus works outside the company, it is difficult for a manager to determine use of an outside work place to be business use or to determine a duration, during which the employee stays outside the company, to be for business.

In the present exemplary embodiment, in the case where an employee uses a designated work place predetermined by an employer or the like as a place for business among work places which may be used by unspecified persons, a manager's determination as to attendance management is assisted by displaying the use of the designated work place as business use on the screen of the manager terminal 20.

The configuration for assisting determination as to attendance management, as described above, will be described below specifically.

### The Employee Terminal 10

The employee terminal 10 is a terminal apparatus for internal and external calling, for example, in the company to which the employee belongs, and for information communication with a text, an image, and the like in the inside and outside of the company or the like through a network. For example, a portable terminal apparatus, such as a smartphone or a tablet terminal, may be used as the employee terminal 10.

The employee terminal 10 according to the present exemplary embodiment has a Global Positioning System (GPS) capability. The employee terminal 10 determines its own position information, and records, in the employee terminal 10, the position information in association with the time information indicating the time point at which the position information is determined. If the employee terminal 10 stays still for a predetermined time or more such as ten minutes and more, the employee terminal 10 according to the present exemplary embodiment records the position information indicating the position in association with the time information.

In the present exemplary embodiment, for example, when an employee clocks in, the power supply of the employee terminal 10 is switched on by the employee. Further, the employee logs in the attendance management server 40 on the employee terminal 10. The login authentication is performed by using a user account which is described below and which is managed by the attendance management server 40. Thus, the employee terminal 10 is associated with the employee using the employee terminal 10.

In the present exemplary embodiment, for example, when the employee clocks out, logout is performed on the employee terminal 10. When logout is performed, the employee terminal 10 transmits the recorded position information and the time information to the attendance management server 40.

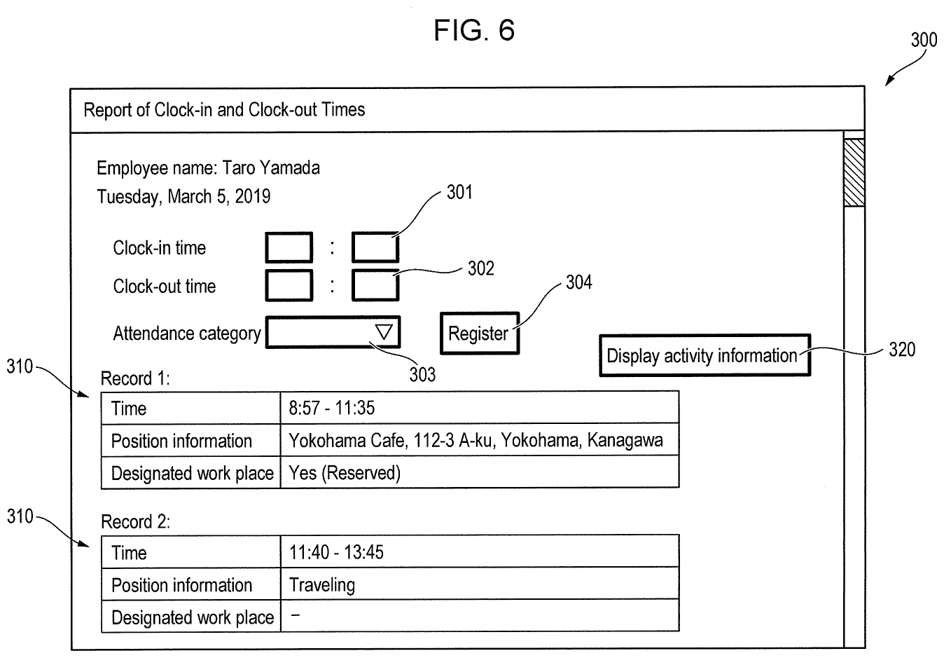

A report reception image 300 (see FIG. 6 described below) for receiving a report about the clock-in and clock-out times from the employee is displayed on the screen of the employee terminal 10 according to the present exemplary embodiment. The employee terminal 10 transmits report information as to the clock-in and clock-out times through the report reception image 300 to the attendance management server 40. In the present exemplary embodiment, the employee themselves reports the clock-in and clock-out times.

### The Manager Terminal 20

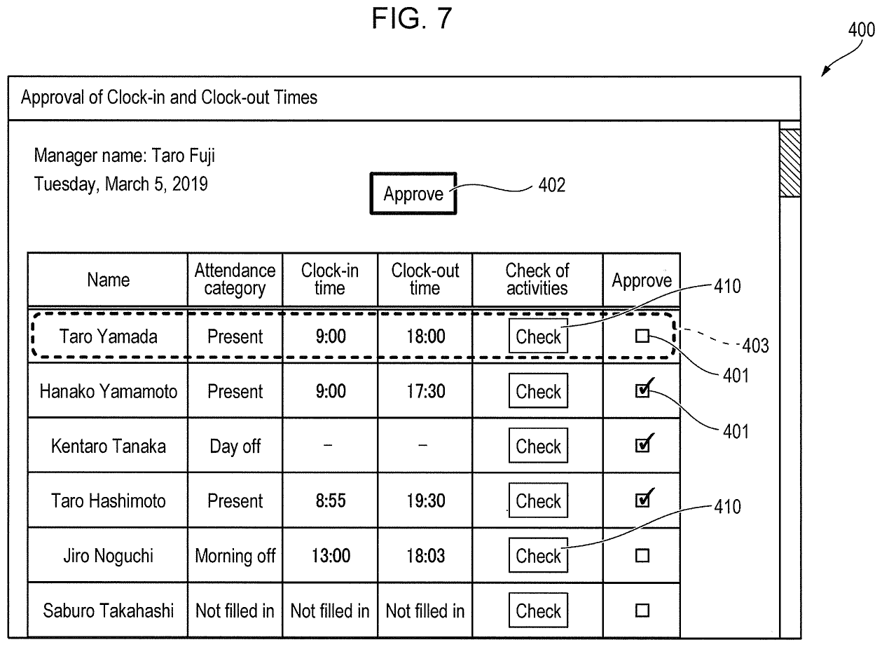

As the manager terminal 20, for example, a stationary terminal apparatus such as a personal computer or a portable information terminal, such as a tablet terminal or a smartphone, may be used. An approval reception image 400 (see FIG. 7 described below) for receiving approval to the clock-in and clock-out times, which are reported by an employee, from the manager is displayed on the screen of the manager terminal 20. The manager terminal 20 transmits the approval information for the clock-in and clock-out times through the approval reception image 400 to the attendance management server 40.

### The Work Place Management Server 30

The work place management server 30 is a server apparatus which manages use of designated work places in which employees work. The designated work places according to the present exemplary embodiment are work places which are located, for example, outside the company and which are designated in advance by an employer or the like of the company. The designated work places according to the present exemplary embodiment may be reserved for use.

An example of a designated work place is a work booth disposed at a location in station premises, an airport, an office building, a department store, a bank, a museum, or the like. The work booth is provided with facilities for an employee to work, such as a desk, a chair, a power supply, a lighting facility, a communication facility, an air conditioning facility, and the like. The work booth according to the present exemplary embodiment is provided with a detection sensor which is capable of detecting presence of a person inside.

An example of a designated work place is an eating place, in which a work table at which work is permitted to be done is disposed, among eating places, such as restaurants and coffee shops. Typically, a table at an eating place is used for a customer at the eating place to eat and drink. In contrast, the work table is, for example, a designated table among the tables in the eating place, and is permitted to be used for work during a predetermined period.

The designated work places are not limited to the examples described above as long as an employee may work and the work places are designated by the company. Thus, various types of work places may be used.

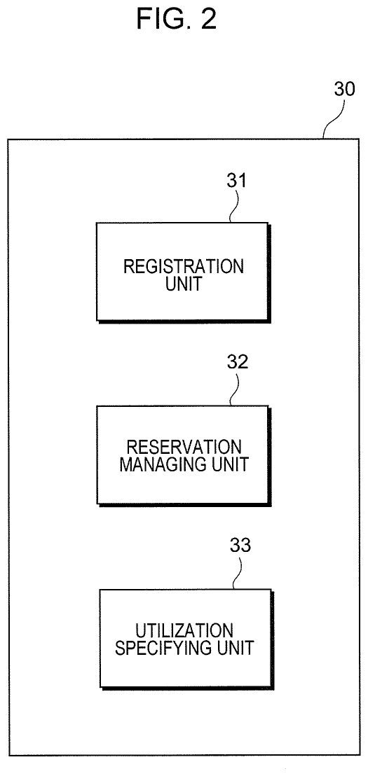

FIG. 2 is a block diagram illustrating the functional configuration of the work place management server 30 according to the present exemplary embodiment.

As illustrated in FIG. 2, the work place management server 30 includes a registration unit 31 which receives registration of the designated work places, a reservation managing unit 32 which manages reservations for the designated work places, and a utilization specifying unit 33 which specifies the employees' utilization of the designated work places.

The registration unit 31 stores the names of the designated work places, position information such as the addresses, available times, and the like. For example, when a table in an eating place is set as a work table, the registration unit 31 receives and registers the name of the eating place, the address of the eating place, and information about times in which the table is available as a work table. Similarly, for example, when a work booth is set as a designated work place, the registration unit 31 receives and registers the name of the work booth, position information with which the work booth may be located, and information about available times of the work booth.

The reservation managing unit 32 displays a reservation reception image on the screen of the employee terminal 10 of an employee who is going to make a reservation. In the reservation reception image, input fields for conditions, which are received from the employee to specify a designated work place, are displayed. The conditions include date-for-use information indicating the desired date of use of a designated work place, time-for-use information indicating the desired time for use of the designated work place, and position-for-use information which indicates the desired place of use of the designated work place. The reservation managing unit 32 presents, to the employee, designated work places, which satisfy the conditions, among the designated work places registered in the registration unit 31. The reservation managing unit 32 determines a designated work place, which is specified by the employee, as a reservation target.

The reservation managing unit 32 may receive cancellation for a reservation before start of the time of use. In addition, the reservation managing unit 32 may receive a change of the time of use before start of the time of use. Further, if another reservation has not been made, the reservation managing unit 32 may receive an extension of the time of use before start of the time of use or during the time of use. In addition, the reservation managing unit 32 may receive a reduction of the time of use before start of the time of use or during the time of use.

To specify the utilization of a designated work place, the utilization specifying unit 33 may use multiple methods described below. The utilization of a designated work place according to the present exemplary embodiment indicates information indicating which designated work place is used by an employee in which duration. The utilization specifying unit 33 transmits, to the attendance management server 40, information about the specified utilization of a designated work place.

The utilization specifying unit 33 according to the present exemplary embodiment uses at least any one of the following methods to specify the utilization of a designated work place: (i) a method using the employee terminal 10; (ii) a method using terminal apparatuses in an eating place; (iii) a method using the detection sensor.

(i) In the case of use of the employee terminal 10, the utilization specifying unit 33 determines whether or not the employee is located in a designated work place on the basis of the position information of the employee terminal 10 carried by the employee. For example, the utilization specifying unit 33 compares the position information of the registered designated work places with the position information determined by using the GPS function of the employee terminal 10, thus specifying which designated work place is used by the employee. In addition, the utilization specifying unit 33 specifies the time of use of the designated work place by using the employee terminal 10.

(ii) In the case of use of terminal apparatuses in an eating place, the utilization specifying unit 33 uses a reception terminal, an accounting terminal, and the like in the eating place. For example, assume that a work table in the eating place has been reserved. When the employee who has made the reservation comes to the eating place, the employee uses the reception terminal to input entry to the eating place. When the employee who has made the reservation finishes the use of the work table and leaves the eating place, the employee pays by using the accounting terminal. The utilization specifying unit 33 determines which designated work place is used by the employee on the basis of information from the eating place associated with the reception terminal and the accounting terminal. The utilization specifying unit 33 specifies the time of use of the designated work place on the basis of information about the entry time, at which the employee enters the eating place, and the leaving time, at which the employee leaves the eating place, which are obtained from the reception terminal and the accounting terminal.

(iii) In the case of use of the detection sensor, the utilization specifying unit 33 uses detection information from the detection sensor which is provided in the work booth and which detects presence of a person inside. For example, when the employee who has made the reservation enters the work booth, the employee is detected by the detection sensor. The utilization specifying unit 33 determines which designated work place is used by the employee on the basis of information of the work booth associated with the detection sensor. The utilization specifying unit 33 specifies the time of use of the designated work place on the basis of information about the entry time, at which the employee enters the work booth, and the leaving time at which the employee leaves the work booth.

### The Attendance Management Server 40

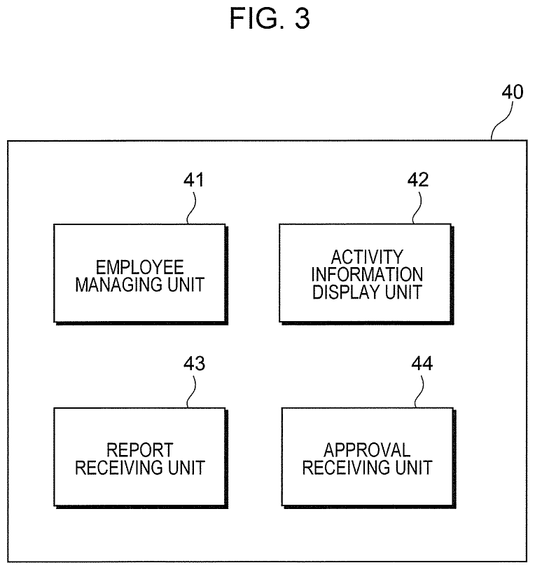

FIG. 3 is a block diagram illustrating the functional configuration of the attendance management server 40 according to the present exemplary embodiment.

The attendance management server 40 includes an employee managing unit 41 which manages information about the employees, an activity information display unit 42 which displays activities of the employees, a report receiving unit 43 which receives reports of clock-in and clock-out times from the employees, and an approval receiving unit 44 which receives, from managers, approval to the clock-in and clock-out times.

In the present exemplary embodiment, the activity information display unit 42 functions as an exemplary specifying unit and an exemplary display unit. The report receiving unit 43 functions as an exemplary receiving unit.

### The Employee Managing Unit 41

The employee managing unit 41 receives registration of the employees belonging, for example, to the company. The employees are registered by a manager inputting information about the employees through the manager terminal 20. The employee managing unit 41 manages the employee names and affiliations. The employee managing unit 41 manages account information, such as login IDs and login passwords of the employee terminals 10 used by the employees.

### The Activity Information Display Unit 42

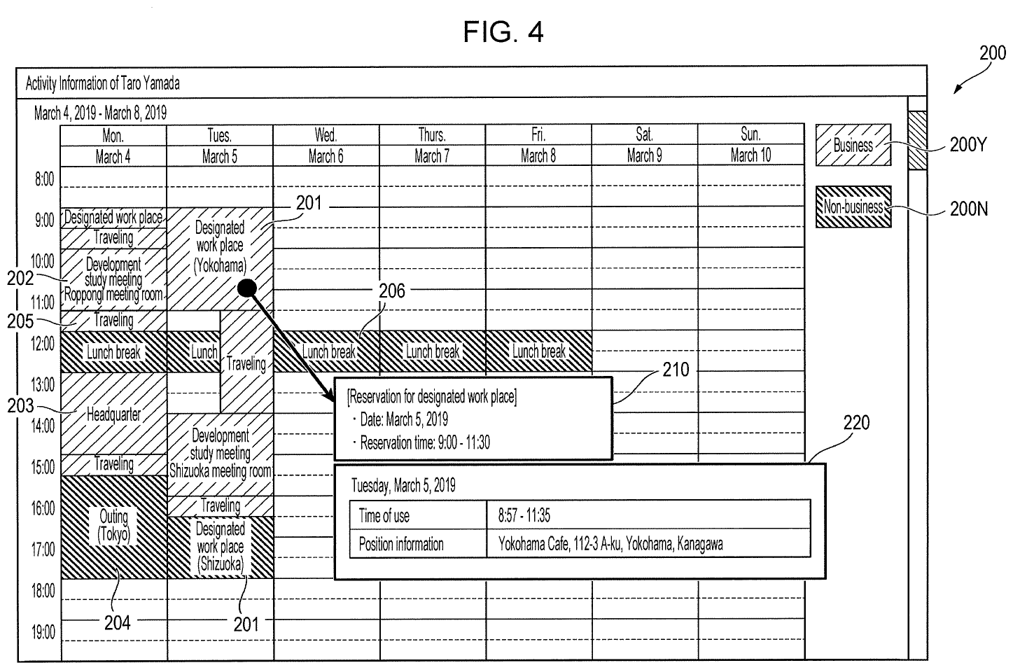

FIG. 4 is a diagram illustrating an exemplary activity information 200 displayed by the activity information display unit 42 according to the present exemplary embodiment.

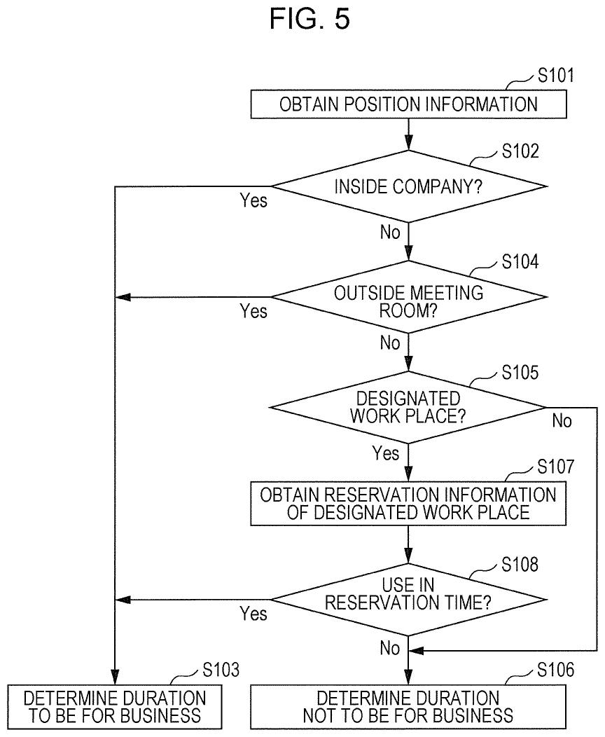

FIG. 5 is a flowchart of determination as to a business duration which is performed by the activity information display unit 42 according to the present exemplary embodiment.

The activity information display unit 42 obtains, from the employee terminal 10, the position information and the time information having been recorded in the employee terminal 10. The activity information display unit 42 according to the present exemplary embodiment determines the location of the employee on the basis of the position information obtained from the employee terminal 10. The activity information display unit 42 according to the present exemplary embodiment refers to a database which is created in advance, and specifically determines the place, such as a company or a facility, corresponding to the position information obtained from the employee terminal 10. The activity information display unit 42 generates the activity information 200 (exemplary location information) in which the employee's locations determined on the basis of the employee's position information are arranged chronologically.

The activity information display unit 42 displays the activity information 200 in response to a request from the manager terminal 20 or the employee terminal 10 on the corresponding screen.

The activity information 200 according to the present exemplary embodiment is edited by neither an employee nor a manager. The activity information 200 is generated on the basis of information, such as the position information and the time information of the employee which are obtained from the employee terminal 10.

As illustrated in FIG. 4, the activity information 200 is generated for each employee. In the activity information 200, the vertical axis represents time and the horizontal axis represents dates. In the activity information 200, information about the employee's locations determined by using the position information is displayed as durations in the times corresponding to the locations.

In the example in FIG. 4, the activity information display unit 42 displays, in the activity information 200, a designated-work-place duration 201 indicating that the employee was present in a designated work place, in a period for which the employee was present in the designated work place. The activity information display unit 42 displays an outside-meeting-room duration 202 indicating that the employee was present in a meeting room outside the company, in a period for which the employee was present in the meeting room outside the company. The activity information display unit 42 displays an in-house duration 203 in a period for which the employee was present in the company. The activity information display unit 42 displays an outing duration 204 in a period for which the employee stayed at a visiting destination. The activity information display unit 42 displays a traveling duration 205 indicating that the employee traveled, in a period for which the employee traveled. The activity information display unit 42 displays a break time duration 206 indicating that the employee took a break, in a predetermined break period.

When, for example, the manager terminal 20 receives a selection operation, such as a double click on a duration in the activity information 200, the activity information display unit 42 displays detailed information about the duration. The detailed information includes, for example, information about the name and address of the place, such as a company or a facility, in which the employee was present, and information about the time in minutes during which the employee stayed in the place.

As illustrated in FIG. 4, in the activity information 200 according to the present exemplary embodiment, when a selection operation is performed on a designated-work-place duration 201, reservation information 210 of the specified work place and the employee's utilization information 220 of the designated work place are displayed in a pop-up window or the like.

The reservation information 210 is displayed on the basis of information about the reservation obtained from the work place management server 30. Specifically, the reservation information 210 includes information about the reserved date and time.

The utilization information 220 includes information about the date of use of the designated work place, information about the time of use of the designated work place, and the position information of the designated work place.

The activity information display unit 42 displays the activity information 200 in such a manner that a duration determined to be for business is differentiated from a duration determined not to be for business. Specifically, the activity information display unit 42 displays the activity information 200 in such a manner that the background color of a duration determined to be for business is different from that of a duration determined not to be for business. In the activity information 200, as illustrated in the explanatory notes, a duration determined to be for business is indicated by using the background of a first explanatory note 200Y, and a duration determined not to be for business is indicated by using the background of a second explanatory note 200N. Thus, the activity information display unit 42 enables a viewer to recognize, in the activity information 200, the differentiation between the determination result, which indicates durations for which the employee worked, and the determination result, which indicates durations for which the employee did not work.

In the example in FIG. 4, the activity information display unit 42 displays the background color, which indicates that a business duration is determined, in the designated-work-place durations 201 (for example, March 5, 9:00 to 11:30) for which a reservation was made, the outside-meeting-room duration 202, the in-the-house duration 203, and the traveling durations 205. In contrast, the activity information display unit 42 displays the background color, which indicates that a non-business duration is determined, in the outing duration 204, the break time durations 206, and the designated-work-place duration 201 (for example, March 5, 16:30 to 18:00) in which no reservation was made.

The determination, which is performed by the activity information display unit 42, as to whether an employee uses a designated work place for business or not for business will be described in detail.

The activity information display unit 42 determines an employee's use of a designated work place, for which a reservation was made, to be business use. In contrast, the activity information display unit 42 determines an employee's use of a designated work place, for which no reservation was made, to be non-business use. The determination is made on the basis of the viewpoint in which an employee may use a designated work place for operations other than business operations. Thus, the activity information display unit 42 according to the present exemplary embodiment uses, in addition to information indicating that the employee was present in the designated work place, information indicating that a reservation was made for the designated work place, so as to determine that the designated work place was used for business. In the present exemplary embodiment, objective information obtained from the work place management server 30, which is a resource different from the attendance management server 40 and which manages the designated work places, is used to determine whether or not a designated work place is used for business.

The activity information display unit 42 determines whether or not the time of use of a designated work place is for business on the basis of the comparison of the time of use with the reservation time of the designated work place. That is, if the time difference between the reservation time and the time of use of the designated work place falls in a predetermined time range, the activity information display unit 42 determines that the time of use of the designated work place was for business. In contrast, if the time difference with the time of use of the designated work place exceeds the predetermined time range, the activity information display unit 42 determines that the excess time was not for business. For example, it may be assumed that an employee, who made a reservation for a work table of an eating place as a designated work place, worked during the reservation time, and ate and drank at the same work table during the excess time. Accordingly, the activity information display unit 42 determines whether or not a duration is for business on the basis of the difference between the time of use and the reservation time of the designated work place.

If there is a time difference, which is larger than a predetermined time, between the time of use of a designated work place and the reservation time of the designated work place, the activity information display unit 42 displays, for the designated-work-place duration 201 in the activity information 200, an alert image related to the difference between the reservation time and the time of use. For example, the activity information display unit 42 may display a message that the time of use exceeded the reservation time if the time of use is longer than the reservation time. Alternatively, the activity information display unit 42 may display, for the duration, a background color which is different from that in the case in which the reservation time corresponds to the time of use. Alternatively, the activity information display unit 42 may display, in the activity information 200, a message indicating an insufficient time of use if the time of use is shorter than the reservation time. Alternatively, the activity information display unit 42 may display, for the duration, a background color which is different from that in the case in which the time of use corresponds to the reservation time.

The determination, which is performed by the activity information display unit 42, as to business durations and non-business durations between the clock-in and clock-out times of an employee will be described.

As illustrated in FIG. 5, the activity information display unit 42 obtains the position information from the employee terminal 10 (S101). The activity information display unit 42 determines whether the employee's location determined by using the obtained position information is inside or outside the company (S102). If the activity information display unit 42 determines that the location of the employee is inside the company (Yes in S102), the activity information display unit 42 determines that the time, during which the employee stayed at the location, is for business (S103).

In contrast, if the activity information display unit 42 determines that the location of the employee is not inside the company (No in S102), the activity information display unit 42 determines whether or not the employee's location determined by using the obtained position information is an outside meeting room (S104). If the activity information display unit 42 determines that the location of the employee is an outside meeting room (Yes in S104), the activity information display unit 42 determines that the time, during which the employee stayed at the location, is for business (S103).

If the activity information display unit 42 determines that the location of the employee is not an outside meeting room (No in S104), the activity information display unit 42 determines whether or not the employee's location determined by using the obtained position information is a designated work place (S105). If the activity information display unit 42 determines that the location of the employee is not a designated work place (No in S105), the activity information display unit 42 determines that the time, during which the employee stayed at the location, is not for business (S106).

In contrast, if the activity information display unit 42 determines that the location of the employee is a designated work place (Yes in S105), the activity information display unit 42 obtains reservation information of the designated work place (S107). The activity information display unit 42 compares the utilization of the designated work place with the reservation state, and determines whether or not the employee's actual time of use of the designated work place is within a reservation time (S108).

If the employee's actual time of use of the designated work place is within a reservation time (Yes in S108), the activity information display unit 42 determines that the time, during which the employee was present at the location, is for business (S103). In contrast, if no reservation was made for the designated work place, the activity information display unit 42 determines that the time, during which the employee was present in the location, is not for business. In addition, if the employee was present in the location even after the reservation time, the activity information display unit 42 determines that the duration after the reservation time is not for business (S106).

As described above, the activity information display unit 42 according to the present exemplary embodiment determines business use in accordance with whether or not a reservation was made for a designated work place. However, if it is use of a designated work place, regardless of whether or not a reservation was made, the use may be determined to be for business. For example, an employee uses a designated work place, which is designated by a company or the like, for business with a probability higher than another work place which is not designated by the company. Thus, if the activity information display unit 42 determines that an employee was present in a designated work place, the activity information display unit 42 regards the employee's use of the designated work place as being for business, and may determine that the use of the designated work place is for business.

### The Report Receiving Unit 43

FIG. 6 is a diagram illustrating an exemplary report reception image 300 displayed by the report receiving unit 43 according to the present exemplary embodiment.

The report receiving unit 43 displays, in the screen of the employee terminal 10, the report reception image 300 for receiving a report of the clock-in and clock-out times from an employee. The report receiving unit 43 receives input of the clock-in and clock-out times from an employee in the report reception image 300. The report receiving unit 43 transmits, to the approval receiving unit 44, information about the clock-in and clock-out times received from the employee, in response to a request from the approval receiving unit 44.

As illustrated in FIG. 6, the report reception image 300 displays a clock-in time input field 301 for an employee inputting the clock-in time, a clock-out time input field 302 for inputting the clock-out time, an attendance-category selection field 303 for selecting the attendance category, and a registration button image 304 for confirming registration of the input times.

The clock-in time input field 301 and the clock-out time input field 302 receive respective specific times. In the attendance-category selection field 303, any category among attendance categories, such as “present”, “day off”, and “half-day”, is selected.

In the report reception image 300, clipping information 310 of the activity information 200, which is specified by the activity information display unit 42 and which is based on the employee terminal 10 of the employee, is displayed. The clipping information 310 is information determined to be for business in the activity information 200. In the report reception image 300 according to the present exemplary embodiment, information about durations, which are determined not to be for business, in the activity information 200 is not displayed. In the report reception image 300, display of the clipping information 310 helps an employee remember their clock-in and clock-out times, and suppresses erroneous time input from the employee. Thus, the correct clock-in and clock-out times are input, resulting in a reduction in the work load on a manager giving approval in the present exemplary embodiment.

In the report reception image 300, a display instruction image 320 for receiving an instruction to display the activity information 200 in the screen of the employee terminal 10 is displayed. When the employee selects the display instruction image 320, the activity information 200 (see FIG. 4) is displayed in the screen of the employee terminal 10.

### The Approval Receiving Unit 44

FIG. 7 is a diagram illustrating an exemplary approval reception image 400 displayed by the approval receiving unit 44 according to the present exemplary embodiment.

The approval receiving unit 44 displays, in the screen of the manager terminal 20, the approval reception image 400 for receiving approval to the clock-in and clock-out times reported by employees. The approval receiving unit 44 receives approval to the clock-in and clock-out times, which are reported by employees, in the approval reception image 400.

As illustrated in FIG. 7, in the approval reception image 400, the attendance category and clock-in and clock-out times are displayed for each employee. Information, which is input by an employee themselves, about the attendance category and clock-in and clock-out times is displayed in the report reception image 300. In the approval reception image 400, select button images 401 for giving a manager's approval are displayed for the respective employees. In addition, an approval decision button image 402 is displayed and is used to confirm the approval to the clock-in and clock-out times of the employees for whom the select button images 401 have been selected. Through selection of a select button image 401, a check mark or the like is explicitly displayed. In the approval reception image 400, selection of the approval decision button image 402 causes the clock-in and clock-out times of employees, for whom the select button images 401 have been selected, to be approved.

In the approval reception image 400, check button images 410 for receiving an instruction to display the activity information 200 in the screen of the manager terminal 20 are displayed in order that a manager checks the activity information 200. When a manager selects a check button image 410, the activity information 200 (see FIG. 4) is displayed in the screen of the manager terminal 20. The approval receiving unit 44 according to the present exemplary embodiment displays the activity information 200 in the screen through the operation on the check button image 410 when necessary. Thus, the approval receiving unit 44 causes, for example, display of other information in the screen not to be hindered compared with the case in which the activity information 200 is always displayed.

As illustrated in FIG. 7, in the approval reception image 400, the approval receiving unit 44 displays an alert image 403 on a target for which the approval receiving unit 44 determines that the information about the clock-in and clock-out times, which are input by an employee, is to be checked by a manager. The alert image 403 is displayed so that the employee, who is a target for which checking is prompted, is differentiated from other employees. In the example in FIG. 7, the alert image 403 is displayed by using a frame with which information about the target employee is surrounded.

The approval receiving unit 44 displays the alert image 403 on the basis of the position information and the time information obtained from the employee terminal 10, the information about utilization of a designated work place, and the like when the clock-in and clock-out times that are input by the employee seem to have a problem. For example, when the time of use of a designated work place and the reservation time exceed a predetermined time range, the approval receiving unit 44 displays the alert image 403 for prompting a manager to check the activity information 200.

As described above, a manager who gives approval may refer to the activity information 200 in the approval reception image 400 and may thus check the determination result about business durations of an employee, resulting in a reduction of the work load of a manager's decision on approval.

The clock-in and clock-out times approved by a manager through the approval receiving unit 44 are used, for example, in calculation of actual working hours which is performed when the manager manages the employees' attendance.

### The Hardware Configurations of the Units

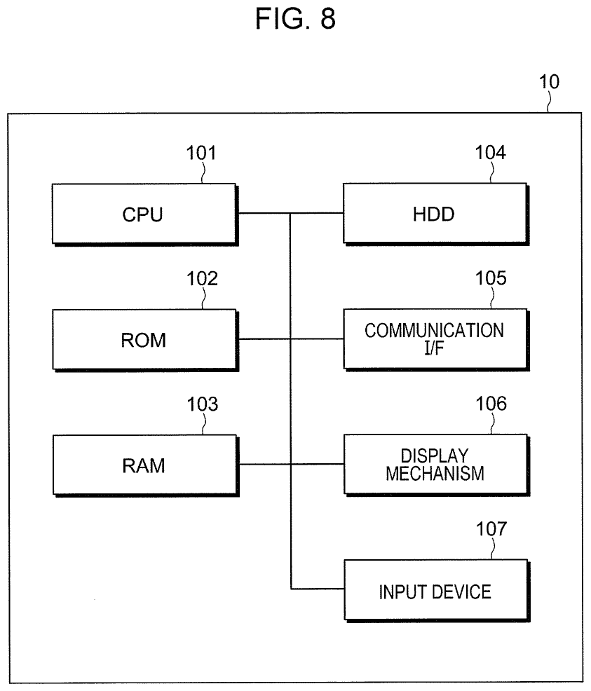

FIG. 8 is a diagram illustrating an exemplary hardware configuration of the employee terminal 10 according to the present exemplary embodiment.

As illustrated in FIG. 8, the employee terminal 10 includes a central processing unit (CPU) 101 which is a computing unit, a read only memory (ROM) 102 which is a storage area in which programs such as a basic input output system (BIOS) are stored, and a random access memory (RAM) 103 which is an area in which programs are executed. The employee terminal 10 includes a hard disk drive (HDD) 104 which is a storage area in which various programs, such as an operating system (OS) and applications, input data for various programs, output data from various programs, and the like are stored. The employee terminal 10 may have multiple CPUs, and the CPUs may collaborate with each other to perform computation. Programs stored in the ROM 102, the HDD 104, or the like are read into the RAM 103 and executed by the CPU 101, thus achieving the functions of the employee terminal 10.

Further, the employee terminal 10 includes a communication interface (communication I/F) 105 for communicating with the outside, a display mechanism 106 such as a display, and an input device 107, such as a keyboard and a mouse or a touch panel.

For the manager terminal 20, the work place management server 30, and the attendance management server 40, for example, a hardware configuration similar to that illustrated in FIG. 8 is used.

The programs for causing the series of functions in the information processing system 1 according to the present exemplary embodiment to be implemented in the employee terminal 10, the manager terminal 20, the work place management server 30, and the attendance management server 40 may be provided, for example, not only by using a communication unit but also by storing the programs in various recording media.

A subset or all of the functional units included in the employee terminal 10, the manager terminal 20, the work place management server 30, and the attendance management server 40 may be implemented by using different apparatuses.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
a specifying unit that specifies an employee's use of a designated work place predetermined as a place for business among work places available to unspecified persons; and
a display unit that, when the employee's use of the designated work place is specified, displays, in a screen, the use of the designated work place as the employee's business use.

2. The information processing system according to claim 1,
wherein, when a reservation for the employee's use of the designated work place has been made, the display unit displays, in the screen, the use of the designated work place as the employee's business use.

3. The information processing system according to claim 1,
wherein, when the employee's use of the designated work place for which a reservation for use has not been made is specified, the display unit displays, in the screen, the use of the designated work place as the employee's non-business use.

4. The information processing system according to claim 2,
wherein, when the employee's use of the designated work place for which a reservation for use has not been made is specified, the display unit displays, in the screen, the use of the designated work place as the employee's non-business use.

5. The information processing system according to claim 2,
wherein the display unit displays, in the screen, an alert image on a basis of a difference between the employee's time of use of the designated work place and a reservation time of the employee's reservation for use of the designated work place.

6. The information processing system according to claim 1,
wherein the display unit displays a duration of the employee's business use in location information in which locations of the employee are displayed chronologically, the display being performed such that the duration of the employee's business use is differentiated from a duration of non-business use of the designated work place.

7. The information processing system according to claim 6,
wherein the display unit displays reservation information about the reservation for use of the designated work place in the location information.

8. The information processing system according to claim 6,
wherein the display unit displays a reception image for receiving an instruction to display the location information, in an approval reception image for receiving a manager's approval to a clock-in time and a clock-out time of the employee, the clock-in time and the clock-out time being reported by the employee.

9. An information processing system comprising:
a specifying unit that specifies a location of an employee;
a receiving unit that receives the employee's report about a clock-in time and a clock-out time in a report reception image; and
a display unit that, in the reporting performed by the employee, displays the employee's location and a duration in the report reception image, the duration being a time during which the employee is present in the employee's location.

10. The information processing system according to claim 9,
wherein the display unit displays the employee's location and the duration in the report reception image, the employee's location and the duration being specified as being related to the employee's business.

11. A non-transitory computer readable medium storing a program causing a computer to execute a process comprising:
specifying an employee's use of a designated work place predetermined as a place for business among work places available to unspecified persons; and
when the employee's use of the designated work place is specified, displaying, in a screen, the use of the designated work place as the employee's business use.

12. A non-transitory computer readable medium storing a program causing a computer to execute a process comprising:
specifying a location of an employee;
receiving the employee's report about a clock-in time and a clock-out time in a report reception image; and
in the reporting performed by the employee, displaying the employee's location and a duration in the report reception image, the duration being a time during which the employee is present in the employee's location.
